(19) United States
(12) Patent Application Publication
(10) Pub. No.: US 2013/0037215 A1
(43) Pub. Date: Feb. 14, 2013

(54) DEVICE FOR THE MASTER MOULDING TECHNIQUE PRODUCTION OF AN INTEGRAL STRUCTURAL COMPONENT MADE OF A FIBRE COMPOSITE MATERIAL REINFORCED BY STRINGERS FOR AN AIRCRAFT

(71) Applicants: Carsten Barlag, Jever (DE); Torben Jacob, Beckdorf (DE); Tobias Dorawa, Hamburg (DE); Alexander Gillessen, Stade (DE)

(72) Inventors: Carsten Barlag, Jever (DE); Torben Jacob, Beckdorf (DE); Tobias Dorawa, Hamburg (DE); Alexander Gillessen, Stade (DE)

(73) Assignee: AIRBUS OPERATIONS GMBH, Hamburg (DE)

(21) Appl. No.: 13/569,237

(22) Filed: Aug. 8, 2012

Related U.S. Application Data
(60) Provisional application No. 61/522,341, filed on Aug. 11, 2011.

(30) Foreign Application Priority Data
Aug. 11, 2011 (DE) 10 2011 109 977.1

(51) Int. Cl. B32B 37/10

(52) U.S. Cl. 156/349

(57) ABSTRACT

A device for the master moulding technique production of an integral structural component made of a fibre composite for an aircraft that is reinforced by stringers includes at least one moulded part forming a mounting surface to create an exterior or interior surface of the structural component, onto which at least one channel for evacuation of the structural component covered by a vacuum film is arranged, with the structural component comprising a skin-like laminate and a plurality of stringers which are disposed spaced apart from one another, wherein at least surface sections between adjacent stringers are covered with an auxiliary stripe, which comprises a textile ventilation fleece which rests on a vacuum film, and a pre-assembled release film firmly connected therewith, the width (B_{F}) of which is greater than or equal to the width (B_{V}) of the ventilation fleece.

### CROSS-REFERENCE TO RELATED APPLICATIONS

The present application claims the benefit of the filing date of U.S. Provisional Patent Application No. 61/522,341 filed Aug. 11, 2011, the disclosure of which is hereby incorporated herein by reference.

### FIELD OF THE INVENTION

The invention relates to a device for the master moulding technique production of an integral structural component made of a fibre composite material reinforced by stringers for an aircraft, comprising a moulded part forming a mounting surface to create an exterior or an interior surface of the structural component, onto which at least one channel is arranged for evacuation of the structural component which is covered with a vacuum film and comprises a skin-like laminate as well as several stringers which are disposed spaced apart from one another.

The area of application of the invention extends to the production of structural components for aircraft, in particular, for commercial aircraft with large-volume fuselages. Such fuselages are usually manufactured applying the shell construction method, wherein a reinforcement structure on the inside bears what is referred to as a skin shell, which forms the exterior surface of the fuselage. The reinforcement structure on the inside usually comprises a plurality of longitudinally running stringers and of ribs that run transversally to them in a roughly annularly manner, which are fastened to the skin shell on the inside. In the modern production technologies of interest here, during the production process of the skin shell at least the stringers are integrally connected to it such that separate connection means—such as rivets—are not necessary for connecting the stringers with the skin shell. To this end, besides applying T-stringers, there is also applied what is referred to as omega stringers, which characterizes the cross-sectional profile of the stringers.

It must be pointed out that, within the present invention, the term “stringer” does not solely refer to an aircraft component. The solution according to the embodiments of the present invention can be applied outside of the area of aircraft construction as well, for example, in the automobile industry or in the construction of wind power installations, which means, in principle, in any area of the generic kind where large-surface stringer-enforced structural components are applied.

Various aspects of the present invention can be applied in conventional hardening processes by means of negative pressure for fibre-reinforced synthetics, wherein the shell that is bearing the stringer profiles is directly mounted onto a laminating adhesive unit (LAU), as well as in advanced processes (AutoVac) that are using mounting carriers and a subsequent transfer to an LAU.

The AutoVac manufacturing process referred to above is a technical solution for an automated positioning of vacuum film, auxiliaries, and stringer profiles by means of a device of interest here. The decisive advantages of the AutoVac manufacturing process are its high degree of accuracy and its reproducibility. The AutoVac manufacturing process can be applied both to Prepreg and to dry fibre production processes. During a resin infusion into a skin-like laminate layer applied to the mounting surface applied during said manufacturing process, said semi-finished fibre products are immersed in the resin, which serves as matrix material, and hardened thereafter. The resin, which is initially liquid, is brought into the semi-finished fibre products by means of negative pressure. Therefore, the device receiving the semi- finished fibre product needs to be sealed to protect it against the surrounding pressure by means of a vacuum film. The resin that is located in the device reacts to the increased temperature and to the vacuum conditions, and the structural component is formed.

### BACKGROUND OF THE INVENTION

DE 103 31 358 A1 discloses a device for the master moulding technique production of an integral structural component made of fibre-reinforced composite material comprising integrated stringers according to the AutoVac manufacturing process. A convex moulded part for positive mounting is equipped with a mounting surface, which is enclosed by an annular channel and covered by film that has been loosely laid on.

By way of the annular channel, the film is drawn by suction towards the contour of the mounting surface, which comprises profile grooves for receiving the stringer profiles. After a sufficient vacuum is obtained, a reel with the factual vacuum skin is coupled with a reel with the film such that the film is rolled up at a short distance and unrolled into the vacuum skin on the mounting surface. By means of a low retention force at the vacuum skin, the latter is drawn accurately into the profile grooves. Subsequently, all stringers are inserted into the profile grooves covered by vacuum film and all skin-like laminate layers are laid onto it. Afterwards, a resin is applied to the outer skin- like laminate layer and a laminated adhesive moulded part is precisely laid onto it and the resin is solidified in advance such that a vacuum-tight sealing between the vacuum skin and the laminated adhesive moulded part is obtained. Then, the cavity between the vacuum skin and the laminated adhesive moulded part is evacuated. After the intended process vacuum is obtained in the cavity between the vacuum skin and the laminated adhesive moulded part, the vacuum is switched off and the laminated adhesive moulded part is raised and turned. After the laminated adhesive moulded part is turned, the structured component pre-assembled such is subjected to an injection process and a hardening process, for example, by entering it into an autoclave under a process vacuum.

In order to harden a synthetic component by means of negative pressure, intermediate cavities between the vacuum film and the skin-like laminate are necessary within the arrangement to evenly distribute the negative pressure over the whole surface of the component and to allow a secure guidance of the gas. These intermediate cavities are usually formed by what is commonly called ventilation fleeces consisting of a textile material that are cut by hand. Separation boundary layers need to be provided to prevent the entry of resin into the textile ventilation fleece.

When using such auxiliaries within the framework of the device according to the invention, the sources of errors during the blank cut by hand are of a disadvantage, because in practice the auxiliaries are roughly cut off from individual material reels and are cut to measure directly at the device. It is difficult to obtain reproducibility and process robustness when individual parts are cut by hand.

### BRIEF SUMMARY OF THE INVENTION

An aspect of the present invention provides a device for the master moulding technique production of an integral structural component using auxiliaries to generate a vacuum, by means of which it is possible to simply and repeatedly safely manufacture the structural component.

An aspect of the invention includes the technical teaching that at least surface sections between adjacent profiles in the region of the mounting surface are covered by a particular auxiliary stripe, which comprises a textile ventilation fleece to be attached to the vacuum film and a release film pre-assembled firmly with it, the width of which is greater than the width of the ventilation fleece.

The advantage of the solution according to an aspect of the present invention, particularly, consists in the fact that individual auxiliary components such as ventilation fleeces and separate release means do not need to be cut manually, but are available pre-assembled such that they may be quickly and precisely arranged at the device. In doing so, particularly the handling is simplified by means of a robust structure and a low number of individual blank cuts. This will lead to an avoidance of mounting errors and to a high reproducibility of component quality. The blank cut of the auxiliaries and the connection of these do not necessarily have to be performed at the location of the device, resulting in the fact that the risk of producing errors decreases when the device is equipped. In addition, the use of the pre-assembled auxiliary stripe according to an aspect of the present invention allows a simple and clearly defined positioning relative to the device.

According to a measure of the present invention, the release film is arranged at the ventilation fleece coaxially overlapping on both sides. The overlapping areas on both sides of the release film in the range of, preferably, from 0 to 10 mm created such allow a simple self-centering between adjacent stringers, fulfil the function of sealing lips in co-action with the vacuum film, and prevent the resin from entering into the textile ventilation fleece, which would obstruct evacuation.

To meet the functions of the release film and the ventilation fleece it is proposed that the release film comprises a synthetic material, preferably ETFE film (ETFE=ethylene-tetrafluoroethylene), and that the ventilation fleece comprises a polyester or a nylon material.

To provide a simple pre-assembling of the ventilation fleece and of the release film, it is proposed to bond the ventilation fleece onto the release film such that an integral connection between both components is obtained. The precisely pre-assembled auxiliary stripe can be made available ready for use in the form of reels.

According to a further measure of the present invention it is proposed that the release film comprises at least one opening to guide the vacuum by means of the auxiliary stripe that is transversally arranged to the guiding auxiliary stripe. Said guiding auxiliary stripes can be used to cover the edge areas of the mounting surface and arrange for a uniform and evenly distributed negative pressure onto the mounting surface without that any additional connecting channels need to be provided at the mounting surface for this purpose.

The solution according to an aspect of the present invention can both be applied to concave laminated adhesive moulded parts and to convex moulded parts, which are usually applied during the AutoVac manufacturing process.

According to another measure of the present invention it is proposed that a plurality of adhesive elements at the side of the release film of the auxiliary stripe is provided for bonding of the auxiliary stripe to the component, ideally, to the already hardened reinforcement profiles. In doing so, despite a possible movement of the moulded part, or in case of vertically standing parts, a simple fixation of the auxiliary stripe at the device or at the component can be obtained.

According to another measure of the present invention it is proposed to provide a plurality of adhesive elements at the fleece side of the auxiliary stripe to bond the auxiliary stripe to the vacuum film that has been applied to the mounting carrier. In doing so, despite of a possible movement of the mounting carrier, or in case of vertically standing parts, a simple fixation of the auxiliary stripes at the arrangement or at the component can be obtained.

If necessary, an additional layer of peel ply may be inserted between the release film of the auxiliary stripe and the skin-like laminate.

### BRIEF DESCRIPTION OF THE DRAWINGS

Further measures of the present invention are shown below together with a description of a preferred example of embodiment of the invention by means of the Figures. The following is shown:

FIG. 1 a device for the production of an integral structural component comprising a concave mounting surface,

FIG. 2 a device for the production of a structural component comprising a convex mounting surface, and

FIG. 3 a perspective view of a section of a pre-assembled auxiliary stripe.

### DETAILED DESCRIPTION

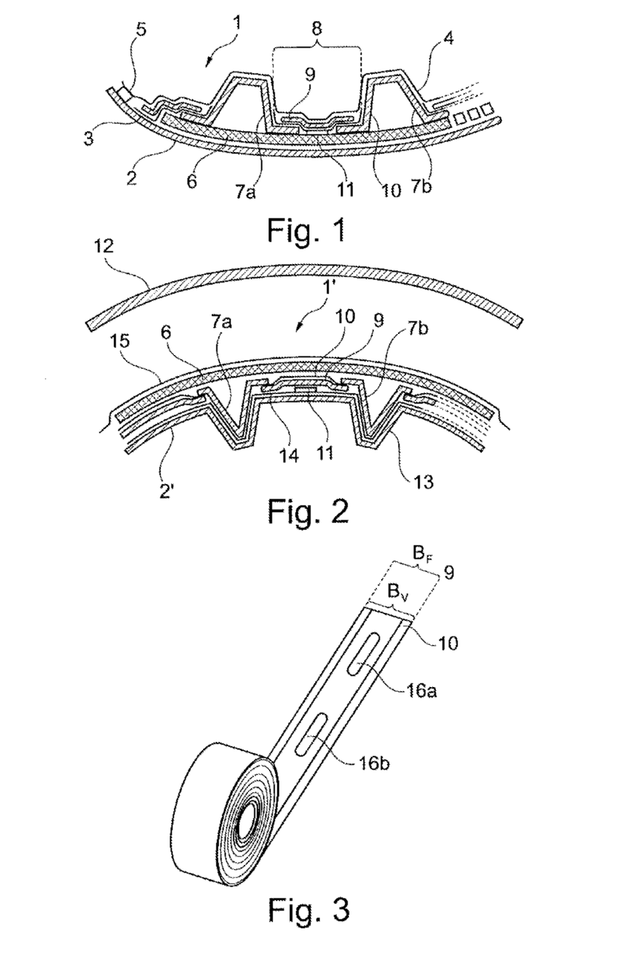

According to FIG. 1, on the side of the release film (10) said auxiliary stripe is fastened by means of an adhesive element (11) after inserting it into the allocated surface section (8). Accordingly, the longitudinal edges of the ventilation fleece (9) of the auxiliary stripe run along each of the bottom-side longitudinal edges of adjacent stringers (7a) and (7b).

According to FIG. 2, a moulded part (2′) comprises a convex mounting surface (1′). The moulded part (2′) is used for positively mounting according to the AutoVac process and co-acts with a laminated adhesive moulded part (12) in a generally known manner.

At the mounting surface (1′) of the moulded part (2′), longitudinal profile grooves (13) are inserted to receive one stringer (7a) or (7b) each. Before the stringers (7a) and (7b) are inserted into the profile grooves (13), the mounting surface (1′) is equipped with a vacuum film (14) for protection of the mounting surface (1′). Subsequently, the pre-assembled auxiliary stripes comprising a ventilation fleece (9) and a release film (10) are placed between the stringers (7a) and (7b) and fixed by means of an adhesive element (11). Afterwards, the stringers (7a) and (7b) are inserted into the profile grooves (13), and a skin-like laminate (6) made of a fibre composite material forming a cover layer completes the layered construction of the structural component. Ultimately, an exterior vacuum film (15) is applied.

FIG. 3 shows a pre-assembled auxiliary stripe comprising a ventilation fleece (9) and a release film (10) bonded thereto. The release film (10) is applied to the ventilation fleece (9) coaxially overlapping on both sides and shows a width B_{F}, which is greater than the width B_{V} of the ventilation fleece (9).

In addition, the release film (10) comprises at its rear area two elongated openings (16a) and (16b), which are situated one behind the other and which serve the guidance of the vacuum to further auxiliary stripes that are arranged transversally to the auxiliary stripe, which are not shown here.

The auxiliary stripe is shown as provided in reel form and can be inserted easily into the intermediate space between adjacent stringers (7a) and (7b) of the structural component in the process of the master moulding technique production.

### LIST OF REFERENCE SIGNS

1 mounting surface
2 moulded part
3 channel
4 vacuum film
5 sealing seam
6 skin-like laminate
7 stringer
8 surface section
9 ventilation fleece
10 release film
11 adhesive element
12 laminated adhesive moulded part
13 profile groove
14 vacuum film
15 vacuum film
16 opening

1. A device for the master moulding technique production of an integral structural component made of a fibre composite material reinforced by stringers, the device comprising:
at least one moulded part forming a mounting surface to create an exterior or an interior surface of the structural component;
at least one channel arranged at exterior or the interior surface for evacuation of the structural component covered with a vacuum film and comprises a skin-like laminate and a plurality of stringers disposed spaced apart from one another,
wherein at least surface sections between adjacent stringers are covered with an auxiliary stripe comprising a textile ventilation fleece attached to a vacuum film and a pre-assembled release film firmly attached to the vacuum film, the width (BF) of the release film being greater than or equal to the width (BV) of the ventilation fleece.

2. The device according to claim 1, wherein the release film is arranged coaxially overlapping on both sides at the ventilation fleece.

3. The device according to claim 2, wherein the overlapping area on both sides of the release film has a width of from 0 to 10 millimetres compared to the ventilation fleece.

4. The device according to claim 1, wherein the release film comprises an ETFE material and the ventilation fleece comprises a polyester or a nylon material.

5. The device according to claim 1, wherein the release film is bonded to the ventilation fleece for pre-assembling the ventilation fleece with the release film.

6. The device according to claim 1, wherein the release film comprises at least one opening for guiding the vacuum to auxiliary stripes arranged transversally to the auxiliary stripe.

7. The device according to claim 1, wherein the moulded part is a concave laminated adhesive moulded part for direct mounting of the device.

8. The device according to claim 1, wherein the moulded part is a convex moulded part for positive mounting of a device, and is configured to co-act with a corresponding laminated adhesive moulded part.

9. The device according to claim 8, wherein the mounting surface of the moulded part comprises a plurality of longitudinal profile grooves to receive one stringer each.

10. The device according to claim 2, wherein the longitudinal edges of the ventilation fleece of the auxiliary stripe are arranged along one bottom-sided longitudinal edge of each of adjacent stringers such that the overlapping area on both sides of the release film is applied at an angled edge area of the stringer.

11. The device according to claim 1, further comprising a plurality of adhesive elements provided at the release film for fastening the auxiliary stripe to the moulded part at the mounting surface.

12. The device according to claim 1, further comprising an additional layer of peel ply arranged between the release film and the skin-like laminate.
